(19) United States
(12) Patent Application Publication
(10) Pub. No.: US 2018/0252945 A1
(43) Pub. Date: Sep. 6, 2018

(54) Front Hanging Eyeglasses

(71) Applicant: Wen-Tse Huang, Kaohsiung City (TW)

(72) Inventor: Wen-Tse Huang, Kaohsiung City (TW)

(21) Appl. No.: 15/450,056

(22) Filed: Mar. 6, 2017

(51) Int. Cl. G02C 7/08; G02C 9/04

(52) U.S. Cl. CPC G02C 7/086; G02C 2200/02; G02C 9/04

(57) ABSTRACT

A pair of front hanging eyeglasses includes a lens frame and two lenses combined with the lens frame. The lens frame includes a connecting arm and at least one fastening portion. The fastening portion includes an upper portion extending outside from a surface of the connecting arm and an extension portion extending downward from the upper portion. A connecting slot is defined between the connecting arm and the at least one fastening portion. A magnet is provided on the upper portion or the extension portion and located in the connecting slot. The fastening portion is adapted to be hung on an iron spectacle frame, and the magnet is magnetically mounted on the spectacle frame for the pair of front hanging eyeglasses adhering to a pair of eyeglasses with a common iron spectacle frame.

### BACKGROUND OF THE INVENTION

### 1. Field of the Invention

The present invention relates to a pair of auxiliary eyeglasses and, more particularly, to a pair of front hanging eyeglasses conveniently hung on an iron spectacle frame.

### 2. Description of the Related Art

Eyeglasses are assistive tools to correct people's poor visions in daily lives. A variety of eyeglasses have been developed for patients who suffer from myopia, hyperopia, amblyopia, or presbyopia. Furthermore, a variety of functional eyeglasses such as sunglasses, polarizers and wind goggles are also invented for users.

Because visual deterioration is common in people who are getting old, a person wearing myopic lenses usually prepares another pair of reading eyeglasses for unexpected needs. Moreover, a person who stays at dazzling outside environment has to wear a pair of polarizers or sunglasses to protect his/her eyes. However, a user who prepares multiple pairs of eyeglasses simultaneously may feel inconvenient.

The so-called front hanging glasses assembly has been created for users who prefer not to bring multiple pairs of eyeglasses simultaneously. A pair of front hanging glasses assembly includes a pair of main eyeglasses and a pair of auxiliary front hanging eyeglasses which can be attached to or removed from the pair of main eyeglasses. The pair of front hanging eyeglasses works as functional lenses, for example, sunglasses or polarizers mostly. A user staying outside and dazzled by fierce sunlight could wear the pair of front hanging eyeglasses in front of the pair of main eyeglasses to filter excessive sunlight without wearing another pair of eyeglasses. As compact and light accessories, a pair of front hanging eyeglasses is easily carried and worn. However, in a conventional front hanging eyeglasses assembly, a pair of front hanging eyeglasses is combined with a pair of main eyeglasses integrally in design but not attached to another pair of main eyeglasses separately. In other words, a pair of conventional front hanging eyeglasses is compatible with a pair of specific main eyeglasses rather than other eyeglasses with ordinary iron spectacle frames.

### BRIEF SUMMARY OF THE INVENTION

Thus, an objective of the present invention is to provide a pair of front hanging eyeglasses which is adapted to be hung on a pair of main eyeglasses with a common iron spectacle frame for more eyeglasses functioning as a pair of front hanging glasses assembly.

To achieve this and other objectives, a pair of front hanging eyeglasses of the present invention includes a lens frame and two lenses combined with the lens frame. The lens frame includes a connecting arm and at least one fastening portion. The at least one fastening portion includes an upper portion extending outside from a surface of the connecting arm and an extension portion extending downward from the upper portion and facing the surface of the connecting arm. A connecting slot facing downward is defined between the connecting arm and the fastening portion. A magnet is provided on the upper portion or the extension portion and located in the connecting slot. The fastening portion of the lens frame is adapted to be hung on a spectacle frame of a pair of main eyeglasses, and the magnet is magnetically engaged on the spectacle frame for the pair of front hanging eyeglasses adhering to the pair of main eyeglasses.

In an embodiment, the at least one fastening portion is designed on a center of the connecting arm.

In another embodiment, the connecting arm is provided with two fastening portions at two lateral ends thereof.

In an embodiment, the lens frame has two grooves opened in a bottom thereof for combination the lenses. The lens frame further has a plurality of screw holes, and a plurality of screws extend through the screw holes for fixing the lenses on the lens frame.

The pair of front hanging eyeglasses of the present invention, which is magnetically hung on an iron spectacle frame of a pair of main eyeglasses through one or two fastening portions as well as magnets, can adhere to more main eyeglasses functioning as a pair of front hanging glasses assembly.

The present invention will become clearer in light of the following detailed description of illustrative embodiments of this invention described in connection with the drawings.

### DESCRIPTION OF THE DRAWINGS

The illustrative embodiments may best be described by reference to the accompanying drawings where:

FIG. 1 is a schematic view of a pair of front hanging eyeglasses according to a first embodiment of the present invention.

FIG. 2 is a schematic view of the pair of front hanging eyeglasses in FIG. 1 and a pair of main eyeglasses.

FIG. 3 is a partial schematic view which illustrates the pair of front hanging eyeglasses combined with the pair of main eyeglasses in FIG. 2.

FIG. 4 is a schematic view of a pair of front hanging eyeglasses according to a second embodiment of the present invention which is combined with a pair of main eyeglasses.

FIG. 5 is a schematic view of a pair of front hanging eyeglasses according to a third embodiment of the present invention.

FIG. 6 is a schematic view which illustrates the pair of front hanging eyeglasses in FIG. 5 combined with a pair of main eyeglasses.

### DETAILED DESCRIPTION OF THE INVENTION

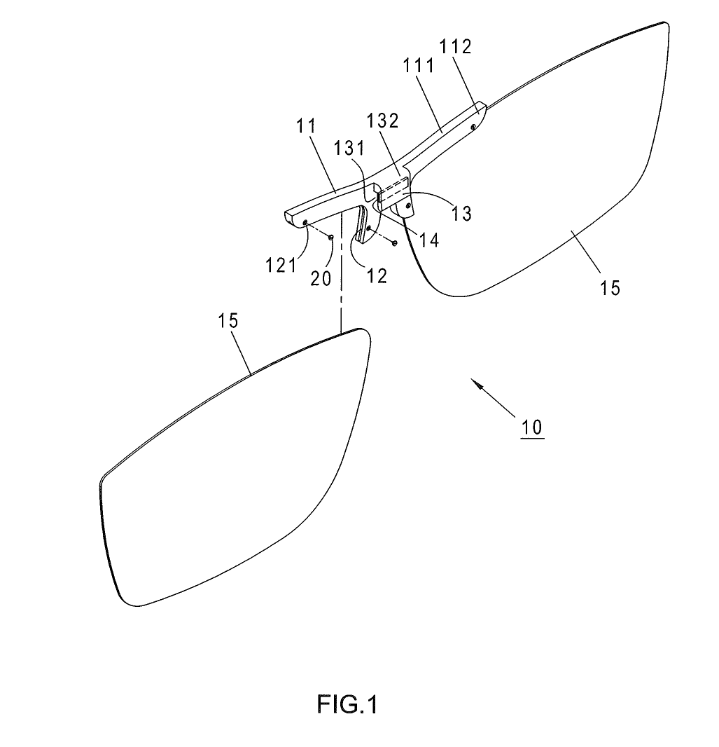

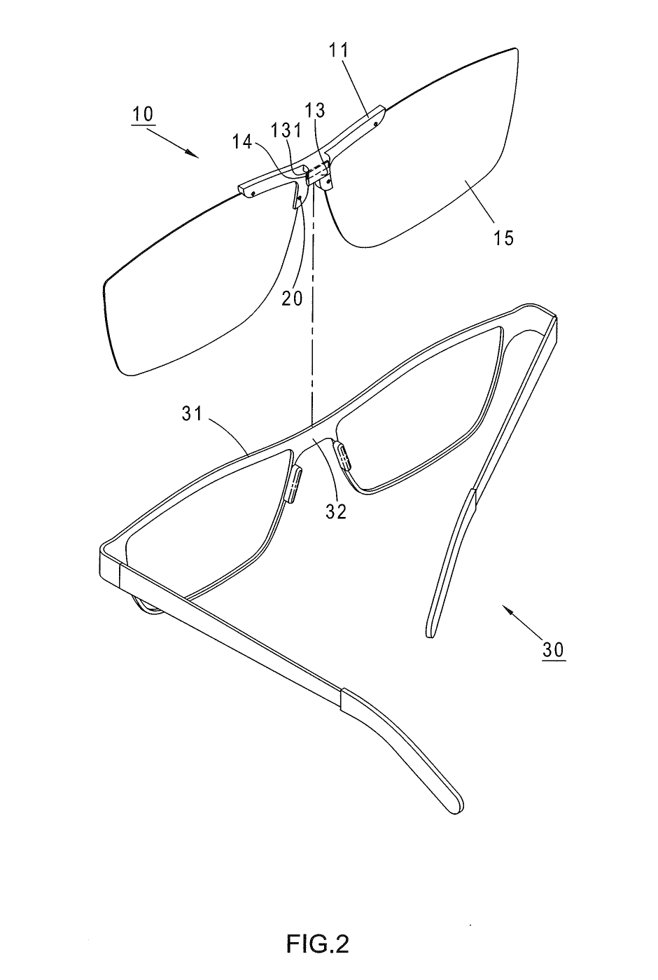

A pair of front hanging eyeglasses according to a first embodiment of the present invention is shown in FIGS. 1 through 3 of the drawings and generally designated 10. The front hanging eyeglasses 10 is adapted to be hung in front of a pair of main eyeglasses 30, so that the pair of main eyeglasses 30 has auxiliary function like a pair of sunglasses, polarizers or reading glasses.

The front hanging eyeglasses 10 includes a lens frame 11 and two lenses 15. In this embodiment, the lens frame 11 includes an elongate connecting arm 111 with a fastening portion 13 centrally. The fastening portion 13 includes an upper portion 132 extending outside from a surface (rear surface) 112 of the connecting arm 111 and an extension portion 133 extending downward from the upper portion 132 and facing the surface 112 of the connecting arm 111. A connecting slot 131 facing downward is defined between the fastening portion 13 and the connecting arm 111, and a permanent magnet 14 is installed inside the connecting slot 131. In this embodiment, the magnet 14 is provided on or embedded in an inner surface 134 of the extension portion 133. Furthermore, the lens frame 11 has two grooves 12, each of which is opened in a bottom of the lens frame 11 for combination of one of the lenses 15. In this embodiment, the lens frame 11 further has a plurality of screw holes 121 penetrated by screws 20, and the lenses 15 abutted by the screws 20 are fixed on the lens frame 11. The lenses 15 function as a pair of sunglasses, polarizers or reading glasses. In this embodiment, the pair of front hanging eyeglasses 10 includes two separate lenses 15. However, the two lenses 15 can be replaced by a single lens.

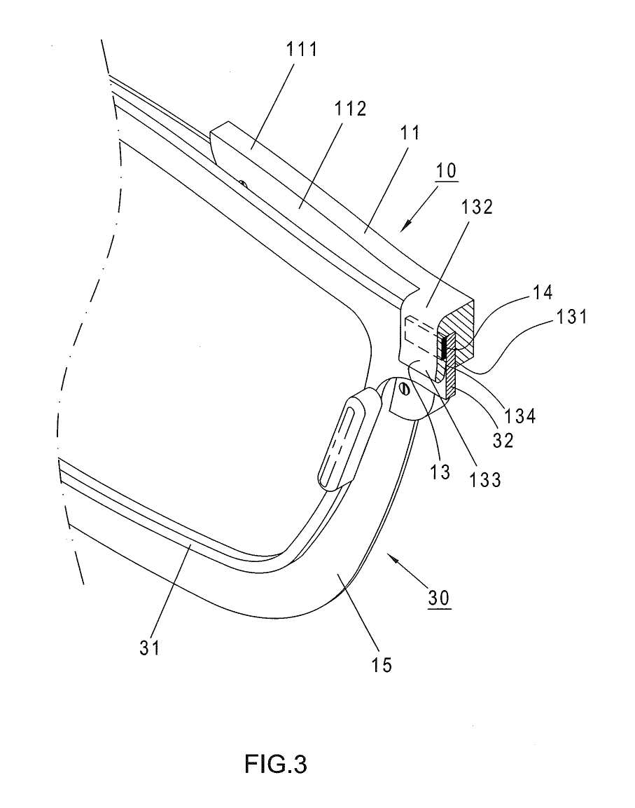

The pair of main eyeglasses 30 includes an iron spectacle frame 31 with a bridge 32 centrally. When the fastening portion 13 is hung on the bridge 32 of the spectacle frame 31 through the connecting slot 131 (FIG. 3), the magnet 14 inside the fastening portion 13 is magnetically engaged on the bridge 32, so that the pair of front hanging eyeglasses 10 can be securely combined with the spectacle frame 31 of the pair of main eyeglasses 30.

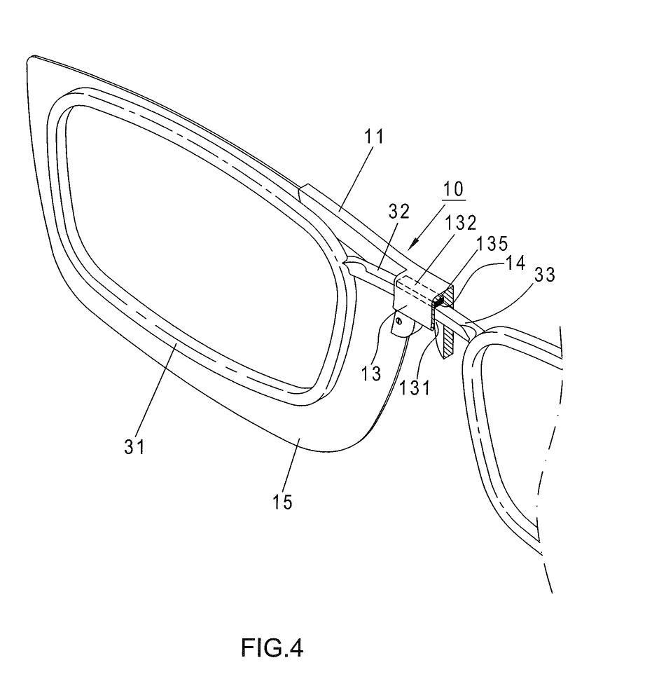

FIG. 4 illustrates a pair of front hanging eyeglasses 10 of the present invention in another embodiment, wherein the magnet 14 is installed on an inner surface 135 of the upper portion 132, and the bridge 32 of the spectacle frame 31 is solid and wide. When the fastening portion 13 is hung on the bridge 32 through the connecting slot 131, the magnet 14 inside the fastening portion 13 is magnetically mounted on a top surface 33 of the bridge 32, so that the pair of front hanging eyeglasses 10 can be securely combined with the spectacle frame 31.

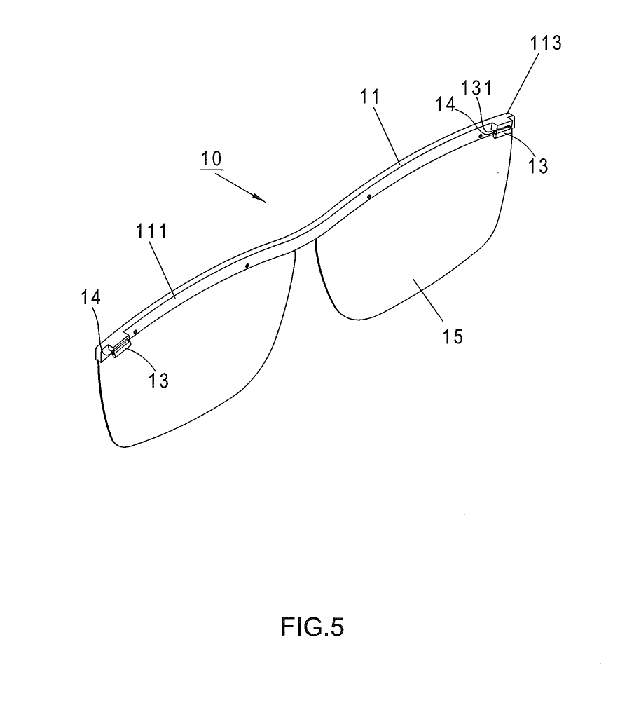

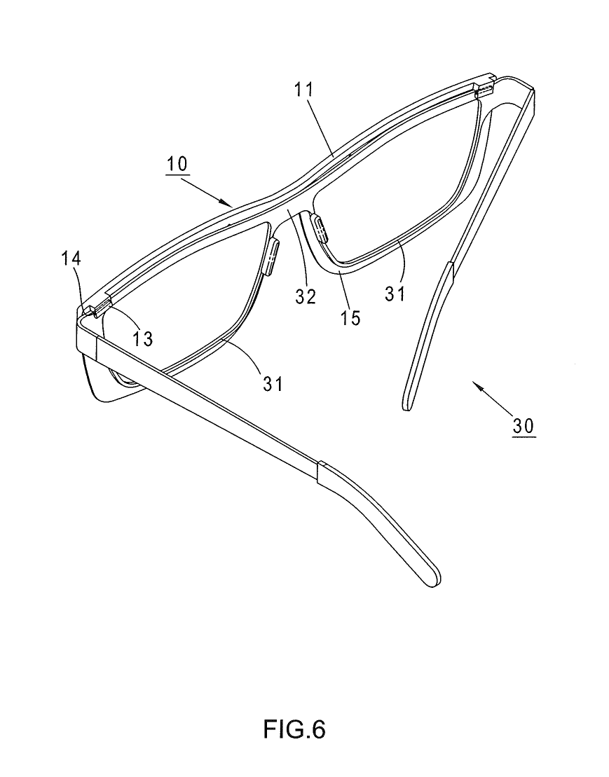

FIGS. 5 and 6 illustrate a pair of front hanging eyeglasses 10 of the present invention in a further embodiment, wherein the connecting arm 111 extends to outer sides of the lenses 15 and is provided with two fastening portions 13 at two lateral ends 112 thereof. Each of fastening portions 13 is provided with a magnet 14 therein. When the pair of front hanging eyeglasses 10 is hung on two sides of the spectacle frame 31 through the fastening portions 13, the magnets 14 inside the fastening portions 13 are magnetically mounted on the spectacle frame 31 of the pair of main eyeglasses 30, so that the pair of front hanging eyeglasses 10 can be securely combined with and easily hung on the pair of main eyeglasses 30.

The pair of front hanging eyeglasses 10 of the present invention can easily adheres to a pair of main eyeglasses with a common iron spectacle frame through one or two fastening portions 13 and magnets 14 for an auxiliary function of the pair of main eyeglasses. Therefore, a user needs not to carry another pair of eyeglasses which functions as a pair of front hanging eyeglasses or buy a pair of new front hanging glasses assembly. In addition, with screws 20 loosened, the original lenses 15 of the pair of front hanging eyeglasses 10 of the present invention can be conveniently replaced with another lenses 15 for another function as required.

The scope of the invention is to be indicated by the appended claims, rather than by the foregoing description, and all changes which come within the meaning and range of equivalency of the claims are intended to be embraced therein.

1. A pair of front hanging eyeglasses comprising:
a lens frame including a connecting arm and at least one fastening portion, with the at least one fastening portion including an upper portion extending outside from a surface of the connecting arm, with an extension portion extending downward from the upper portion and facing the surface of the connecting arm, with a connecting slot defined between the connecting arm and the at least one fastening portion, with a magnet provided on the upper portion or the extension portion and located in the connecting slot; and
at least one lens combined with the lens frame,
wherein the fastening portion of the lens frame is adapted to be hung on a spectacle frame of a pair of main eyeglasses, with the magnet magnetically engaged on the spectacle frame for the pair of front hanging eyeglasses adhering to the pair of main eyeglasses.

2. The pair of front hanging eyeglasses according to claim 1, wherein the at least one fastening portion is designed on a center of the connecting arm.

3. The pair of front hanging eyeglasses according to claim 1, wherein the connecting arm is provided with two fastening portions at two lateral ends thereof.

4. The pair of front hanging eyeglasses according to claim 1, wherein the lens frame has two grooves opened in a bottom thereof for combination the at least one lens, with the lens frame further having a plurality of screw holes, and with a plurality of screws extending through the screw holes for fixing the at least one lens on the lens frame.
